(19) United States
(12) Patent Application Publication
(10) Pub. No.: US 2016/0164299 A1
(43) Pub. Date: Jun. 9, 2016

(54) APPARATUS FOR THE CONVERSION AND OPTIMIZED CONSUMPTION MANAGEMENT OF POWER FROM RENEWABLE SOURCES

(71) Applicant: ABB TECHNOLOGY AG, Zurich (CH)

(72) Inventors: Andrea BECATTINI, Cavriglia (IT); Guido FIESOLI, Bagno a Ripoli (IT); Sauro MACERINI, Bucine (IT)

(21) Appl. No.: 14/956,999

(22) Filed: Dec. 2, 2015

(30) Foreign Application Priority Data
Dec. 4, 2014 (EP) 14196363.7

(51) Int. Cl. H02J 3/38; H02M 7/44; H02J 7/00; H02M 3/04

(52) U.S. Cl. CPC H02J 3/383; H02J 3/386; H02M 3/04; H02M 7/44; H02J 7/0068

(57) ABSTRACT

An apparatus for the conversion and optimized management of power produced from renewable sources, and in particular from solar sources, in the household environment and not only, adapted to control the use of power in order to maximize the management cost-effectiveness whilst ensuring the optimization of the energy collection by the photovoltaic generator.

### FIELD OF THE INVENTION

The present invention relates to systems for the conversion of power, in particular, but not exclusively, the present invention relates to systems for converting power produced by photovoltaic panel systems and adapted to be connected directly to the power grid.

### BACKGROUND ART

In the technical field of power conversion and, in particular, in the technical field of systems for the conversion of power produced by photovoltaic panel and wind systems, adapted to be connected directly to the power grid, managing the power consumption, in the household environment and not only, in the presence of power generation systems from renewable sources, is increasingly important.

Systems of this type comprise a generator of power from alternative sources, such as photovoltaic panels, associated with an inverter apparatus in turn connected to the alternating voltage power grid and possibly to a group of storage batteries, adapted to operate, also in the presence of said grid AC voltage, to optimize the transfer of power to and from the grid.

Said inverter apparatus, for example comprising a double conversion stage consisting of a first DC-DC converter and a second DC-AC converter, is adapted to convert the power from the alternative source (the photovoltaic panel, the wind turbine etc.) into alternating power for the supply to the primary power grid (e.g. ENEL grid).

In the case of renewable sources including, in particular, photovoltaic generators, the power conversion systems of the type described have to manage the production of power by the photovoltaic generator and the supply of said power to the primary power grid.

In addition to this, systems of this type must manage the rules that the power distribution provider normally imposes on the supply of power produced locally in the grid, rules which are becoming increasingly stringent and burdensome for the users. These rules ensure that the ideal situation for a household installation is the one in which said household installation is as independent from the power grid as possible, both as regards the use of energy—self-produced energy is obviously more convenient than that taken from the power grid—and as regards the supply of self-produced power to the grid, which is subject to increasingly stringent constraints and is increasingly less convenient, when not already burdensome, for individual users.

Therefore, an object of the present invention is the provision of an apparatus for the conversion and optimized management of power produced from renewable sources, and in particular from solar sources, for household use and not only, adapted to control the use of power in order to maximize the management cost-effectiveness whilst ensuring the MPPT (Maximum Power Point Tracking), i.e. maximizing the energy power collection by the photovoltaic generator.

Another object of the present invention is the provision of a photovoltaic system for the production of power comprising an apparatus for the conversion and optimized management of the use of power in the household environment and not only, adapted to control the use of the power produced so as to maximize the management cost-effectiveness.

### BRIEF DESCRIPTION OF THE DRAWINGS

Further objects, features and advantages of the present invention will become more apparent from the following detailed description, given by way of a non-limiting example and shown in the accompanying figures, in which:

FIG. 1 shows a schematic block diagram of a preferred embodiment of the apparatus for the conversion and management of the power produced from renewable sources and adapted to be connected directly to the power grid, according to the present invention;

FIG. 2 shows the pattern of the typical power production of a photovoltaic generator during a day;

FIG. 3 shows the pattern of the typical power production of a photovoltaic generator during a day in relation to the limit imposed by some power grid providers, on the amount of self-produced power that can be supplied to the power grid; and

FIG. 4 shows one of the preferred operating modes of the power conversion and management apparatus according to the present invention.

### DETAILED DESCRIPTION OF THE INVENTION

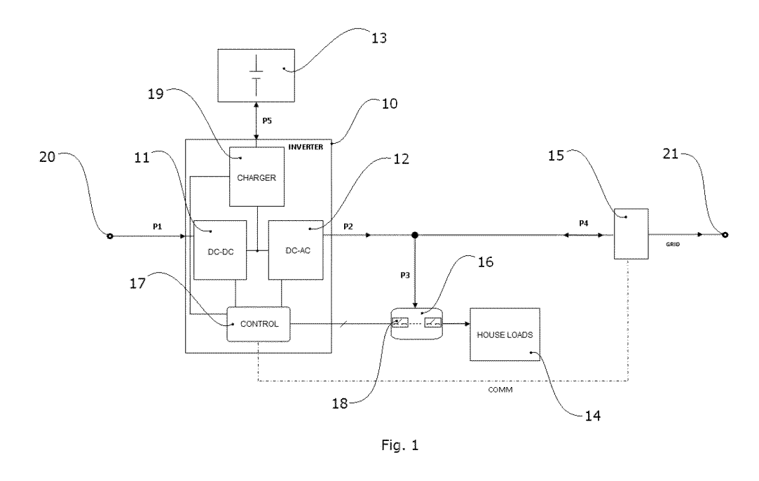

With reference to the accompanying FIG. 1, the apparatus according to the present invention comprises:

input terminals 20 coupled to a DC voltage preferably coming from a generator of renewable power, for example based on photovoltaic or wind sources;

an inverter module 10 in turn comprising
a first DC-DC conversion stage 11, connected in input to said input terminals 20,
a second DC-AC conversion stage 12, having the input coupled to the output of said first DC-DC conversion stage 11 and the output connected to the power grid 21,
a battery-charger module 19 associated in input to the output of said first DC-DC conversion stage 11 and to the input of said second DC-AC conversion stage 12,
a control module 17 adapted to adjust the operation of said inverter module 10;

a battery module 13 associated, through said battery-charger module 19, to the output of said first DC-DC conversion stage 11 and to the input of said second DC-AC conversion stage 12 according to a configuration commonly called “DC link system”, said battery module 13 being adapted to store power from said first stage 11, during recharge, and to supply energy to said second stage 12 during discharge;

at least one house load 14 associated to the output of said second stage 12 and to the power grid 21;

power measurement means adapted to measure the power in input and output to/from said inverter module 10 and the power absorbed by or supplied to grid 21;

a switching module 16 adapted to control the switching on or off of said at least one house load 14.

Said control module 17 is further associated to said power measurement means and to said switching module 16 and to a user interface, preferably comprising at least a display and a keyboard.

Said power measurement means preferably comprises a bidirectional meter device 15 of the AC power consumption connected between the output of said second stage 12 and the power grid 21, downstream of said at least one house load 14.

In further detail, said first DC-DC conversion stage 11 is adapted to convert the input direct voltage from a renewable source—such as a photovoltaic generator—in a direct voltage of different level and to adjust the load of the photovoltaic generator so as to optimize the operation thereof, for example, in the case of photovoltaic sources, by applying the known MPPT (Maximum Power Point Tracking) techniques.

Said second DC-AC conversion stage 12 is adapted to convert the direct voltage in output from said first stage 11 into an alternating voltage adapted to be supplied to grid 21 and to supply electrical loads such as household appliances and the like;

Said control module 17, in particular, by suitably interacting with said power meter means and with said switching module 16, is adapted to manage the use of the power produced from said renewable source so as to maximize the management cost-effectiveness, in particular by maximizing the so-called self-consumption, defined as the ratio between the amount of self-produced power or electrical energy that is consumed by the user in his home and the total amount of self-produced power or electrical energy, and the maximization of self-sufficiency, i.e. the ratio between the portion of power or electrical energy produced and used locally and the total amount of power or electrical energy consumed by the user in his home.

More generally, the control module 17 of the apparatus according to the present invention allows adjusting the operation of said inverter module 10 and of said switching module 16, so that the combination of the value of the input and output power to/from said inverter module 10 and of the value of the power absorbed by or supplied to grid 21, is approximately equal to a required value.

In this way, by acting on appropriate combinations of the various powers involved, each one optionally weighted by suitable and predefined multiplicative coefficients, for example having a value between 0 and 1, it is possible to adapt the operation of the apparatus according to the present invention to all the various conditions, optimizing the behavior thereof as a function of the result to be achieved such as cost-effectiveness, own consumption, energy self-sufficiency, etc.

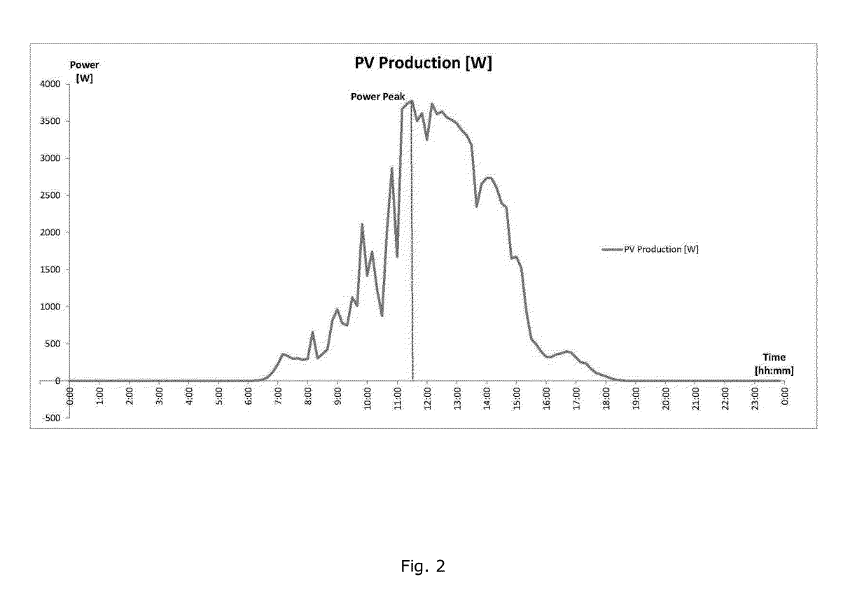

Considering, for example, a renewable energy source consisting of a photovoltaic generator, the graph shown in the accompanying FIG. 2 represents the production of said photovoltaic generator in a typical day. The vertical line indicates approximately the energy production peak time.

With reference to the inverter module 10 described, in one of the selectable operating modes we have that before the time in which there is the greatest power production it is preferable to fully utilize the power contained in said group of batteries 13 to meet the demand of said at least one house load 14. In fact, in the next hours, a considerable amount of power produced by said photovoltaic generator will still be available to fully charge the battery so as to meet the evening consumption peak of said at least one house load 14.

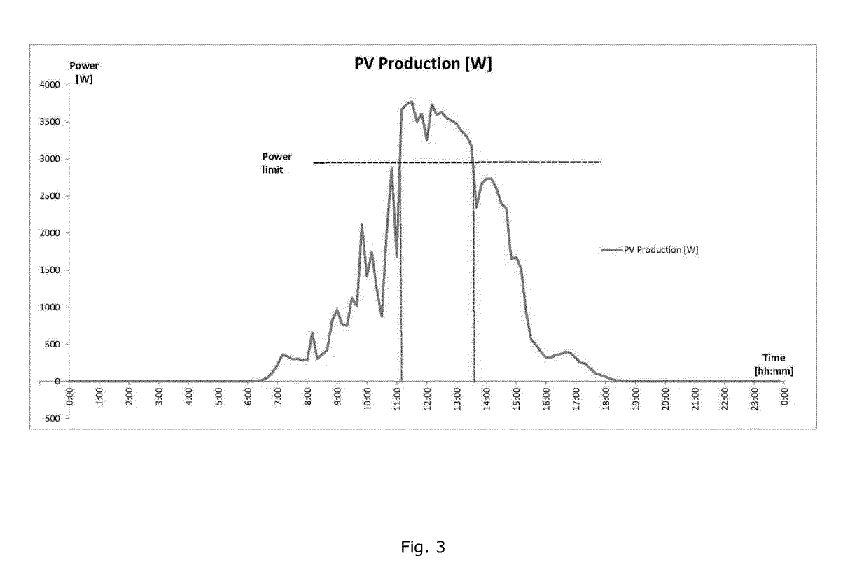

The graph shown in the accompanying FIG. 3 still represents the production of said photovoltaic generator in a typical day, in relation to the limit, often imposed by grid 21 providers and represented by the horizontal line, on the amount of self-produced power that can be supplied to the grid freely or at least without incurring reductions of the incentive rate or even sanctions. The leftmost vertical line indicates the time at which the above limit is exceeded.

Before reaching the above limit time, therefore, it is preferable to fully use the energy contained in said group of batteries 13 to meet the demand of said at least one house load 14. The objective therefore is to reach the time when the production limit is exceeded with the group of batteries 13 containing the minimum possible amount of power so as to be able to absorb the excess of self-produced power by recharging said group of batteries 13.

In the latter case, said group of batteries 13 is thus used as power buffer able to optimize the self-produced power management both for the loads to be supplied and for the provider's requirements governing and restricting the supply of self-produced power to the grid.

To further optimize the management of self-produced power, said switching module 16 connects or disconnects the output of said second stage 12 with said at least one house load 14 so as to maximize the management cost-effectiveness, in particular by maximizing the so-called self-consumption, defined as the ratio between the amount of self-produced power that is consumed by the user in his home and the total amount of self-produced power, and the maximization of self-sufficiency, i.e. the ratio between the portion of power produced and used locally and the total amount of power consumed by the user in his home.

In a preferred embodiment of the present invention, said switching module 16 includes at least one controlled switch 18 adapted to stop or enable the supply of power to said at least one house load 14.

In another preferred embodiment of the present invention, said switching module 16 may be implemented through any communication line, either wired or wireless, able to drive the switching on or off of house loads provided with a suitable communication interface (so-called smart appliances).

With reference to the accompanying FIG. 1, we can see power P1 produced by the photovoltaic generator, power P2 in output from said second stage 12, power P3 which supplies said at least one house load 14, the bidirectional power P4 which flows from (in this case indicated as P4−) and to (in this case indicated as P4+) said bidirectional meter device 15 and power P5—bidirectional too—which flows from (in this case indicated as P5+) and to (in this case indicated as P5−) said group of batteries 13 during the discharge and recharge steps, respectively.

Power P2 generated by the inverter module 10 is a function of both the renewable power available P1 (maximized, for example, through an MPPT algorithm implemented by said control module 17) and of power P5 that can be supplied or absorbed by the battery.

In fact, said control module 17 reads the bidirectional meter device 15 and receives information about the amount of power P4 exchanged with the grid. At this point, said control module 17 adjusts the operation of said inverter module 10 so as to keep power P4, exchanged with the grid, at a threshold set by the user by varying the contribution of power P5 exchanged with said group of batteries 13. In addition, said control module 17 controls said switching module 16 so as to switch on or off a house load (boiler, heater, etc.). The control module 17 therefore acts so as to also vary the household consumptions P3 according to the needs, based on the user's settings and on the value of instant powers P1, P2, P5 and P4 measured.

For example, said control module 17 can operate so as to maximize the self-consumption, as defined above, in addition to the renewable power available P1, through, for example, the use of a suitable MPPT algorithm. The amount of self-produced power that is consumed by the user within his home is therefore equal to the self-produced power (equal to the product of the self-produced power P2 by time t) decreased of the power supplied to grid 21 (equal to the product of power P4+ flowing to said bidirectional meter device 15 by time t).

Therefore, in general terms, the aim is to maximize the following ratio:

[(P2)*t−(P4+)*t]/P2*t.

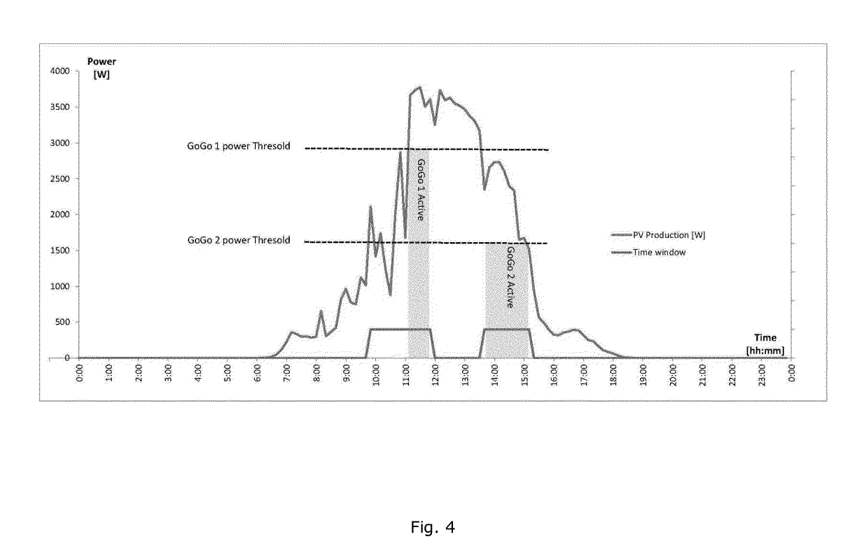

To do so, said control module 17 can operate so as to drive said switching module 16 according to the following modes:
a) The adjustment of said inverter module 10 and the switching on of said switching module 16, and thus the closure of one or more switches 18 belonging to it, are dependent on the achievement, by the self-produced power P4+ which is supplied to grid 21 and is detected by said bidirectional meter device 15, of a threshold (P4+)ₜₕ. In practice, when the amount of self-produced power which is supplied to the grid P4+ becomes too large and is likely to become an undesired excess for the provider or the user, one or more of said at least one house load 14 is activated so as to use this excess for household appliances connected to said inverter module 10. In this case, self-consumption is maximized by keeping the ratio [(P2)*t−(P4+)*t]/P2*t high and exceeding the limits imposed by the provider on the amount of self-produced power supplied to the grid is prevented as well. If the activation of one or more of said at least one house loads 14 is not sufficient to fall within the limits desired, in this operating mode it is possible to further limit the power generated by said inverter of said second stage 12.
b) The adjustment of said inverter module 10 and the activation of said switching module 16, and thus the closure of one or more of the switches belonging to it, are dependent on the achievement of a threshold for the level of self-produced power P4+ that is supplied to grid 21. In practice, when the amount of self-produced power that is supplied to grid P4+ becomes too large and exceeds a certain activation threshold, the amount of power P5− which is used is increased to charge said group of batteries 13 and/or one or more of said at least one house loads 14 is activated. The goal, in this case, is both to prevent exceeding the limits set by the provider on the amount of self-produced power and supplied to the grid and to maximize self-consumption by assigning a priority to the house loads 14 in relation to the battery charge while always maximizing the available renewable power P1 through, for example, the use of a suitable algorithm MPPT. Since loads 14 are priority, in order to meet the requirements of a load the battery charge may be interrupted and it may also be set to discharge. If the activation of one or more of said at least one house loads 14 is not sufficient to fall within the limits desired and the limit of self-produced power P4+ that is supplied to the grid imposed by the grid provider is still exceeded, in this operating mode it is possible to limit power P2 generated by said inverter of said second stage 12.
c) The activation of said switching module 16, and thus the closure of one or more of the switches belonging to it, are dependent on the achievement of a threshold for the level of power P2 supplied by said second stage 12. In practice, when the amount of power supplied by the inverter of said second stage 12 becomes too large and exceeds the activation threshold, one or more of said at least one house loads 14 is activated. In this case, it is not necessary to use said bidirectional meter device 15, since power P2 is read directly by the inverter of said second stage 12 and having to reduce power P2 as in previous case b) is also prevented.
d) The adjustment of said inverter module 10 and the activation of said switching module 16, and thus the closure of one or more of the switches belonging to it, take place in such a way as to give higher priority to the discharge of said battery module 13 (for example using the power contained therein for supplying said at least one house load 14 and/or to send it, converted into AC, to grid 21) in a first time window and then give, in a second time window, higher priority to the charging of said battery module 13. In this way, it is ensured that said battery module 13 contains the least possible amount of power at the end of said first time window, making itself available to accumulate a possible excess of power provided in input to said inverter module 10 in successive time windows.
e) As shown in the accompanying FIG. 4, said switching module 16 is associated with a plurality of time windows within which a different activation threshold is evaluated, relative to a different control parameter. In this way, said activation threshold may be related to the self-produced power P4+ that is supplied to grid 21, to the sum of the self-produced power supplied to the grid and of the battery charge power (P4+)+(|P5−|), or to the photovoltaic power P1 generated.

Other operating modes may be programmed and selected by the user by acting on said control module 17 through the respective user interface, preferably comprising at least a display and a keyboard.

It is also clear that the operating modes described, based on the reading, calculation and setting of power values, may of course be extended to similar operating modes not based on the power value but on the electrical energy power, simply by introducing a suitable reference time interval since energy, as known, is equal to power multiplied by time.

We claim:

1. An apparatus for the conversion and management of power comprising:
input terminals coupled to an input DC voltage;
an inverter module comprising a first DC-DC conversion stage, connected in input to said input terminals, a second DC-AC conversion stage having the input coupled to the output of said first DC-DC conversion stage and the output connected to the power grid, a battery-charger module associated in input to the output of the first DC-DC conversion stage and to the input of said second DC-AC 12 conversion stage, and a control module adapted to adjust the operation of said inverter module;
a battery module coupled to the output of said battery-charger module, said battery module being adapted to store power from said first DC-DC conversion stage, during recharge, and to supply power to said second DC-AC conversion stage during discharge;
at least one house load associated to the output of said second stage and to the grid;
power meter means adapted to measure the power in input and in output to/from said inverter module and the power absorbed by or supplied to the grid;
a switching module associated to said at least one house load and adapted to control the switching on and off of said at least one house load;
wherein said control module is further associated to said power meter means and to said switching module and is adapted to adjust the operation of said inverter module and of said switching module so that the combination of the value of the input (P1, P5+) and output (P2, P5−) power to/from said inverter module and of the value of the power absorbed (P4−) by or supplied (P4+) to the grid, multiplied by suitable multiplicative coefficients, is substantially equal to a required value.

2. The apparatus according to claim 1, wherein said control module is adapted to adjust the operation of said inverter module and of said switching module according to an operating mode adapted to maximize the ratio between the self-produced power fraction (P1) which is absorbed by said at least one house load, and the total self-produced power (P1).

3. The apparatus according to claim 1, wherein said control module is adapted to adjust the operation of said inverter module and of said switching module according to an operating mode adapted to maximize the ratio between the self-produced power fraction (P1) which is absorbed by said at least one house load, and the total power (P3) absorbed by said at least one house load.

4. The apparatus according to claim 1, wherein said control module is adapted to adjust the operation of said inverter module and of said switching module according to an operating mode adapted to limit the power (P4+) in output from said second stage which is supplied to the power grid by increasing the power (P3) absorbed by said at least one house load.

5. The apparatus according to claim 1, wherein said control module is adapted to adjust the operation of said inverter module and of said switching module according to an operating mode adapted to limit the power (P4+) which is fed to the grid by increasing the power (P5−) in output from said battery-charger module.

6. The apparatus according to claim 1, wherein said control module is adapted to adjust the operation of said inverter module and of said switching module according to an operating mode adapted to give priority to the discharging of said battery module in a first time window and to give priority to the charging of said battery module in a second time window.

7. The apparatus according to claim 1, wherein said control module is adapted to define a plurality of time windows, within the same day, on which different operating modes are applied.

8. The apparatus according to claim 1, wherein said control module comprises a user interface comprising at least a display and a keyboard.

9. The apparatus according to claim 1, wherein said switching module comprises at least a controlled switch adapted to interrupt or enable the supply of power to said at least one house load.

10. The apparatus according to claim 1, wherein said switching module comprises a communication interface, wired or wireless, adapted to drive the switching on or off of said at least one house load, said at least one house load being provided with communication means compatible with said communication interface.

11. The apparatus according to claim 1, wherein said DC input voltage coupled to said input terminals is produced by a generator of renewable power based on photovoltaic sources.

12. The apparatus according to claim 11, wherein said first DC-DC conversion stage is adapted to adjust the load of the generator of renewable power based on photovoltaic sources by applying an MPPT algorithm.

13. A photovoltaic apparatus for the production and supply of single-phase or three-phase alternating power to a public grid or a house load comprising:
at least one photovoltaic panel comprising an electrical output, adapted to be exposed to the solar radiation for receiving solar energy and adapted to produce direct voltage and power starting from said solar energy;
an apparatus for the conversion and management of power comprising input terminals connected to the electrical output of said photovoltaic panel and an electrical output, said apparatus for the conversion and management of power being adapted to convert said direct voltage and power into single-phase or three-phase alternating voltage and power and supply it, through said electrical output, for use by a public grid or a house load connected to said electrical output, wherein said apparatus for the conversion and management of power is of the type according to claim 1.
